(19) United States
(12) Patent Application Publication
(10) Pub. No.: US 2023/0140465 A1
(43) Pub. Date: May 4, 2023

(54) REMOVABLE BRUSH HEAD

(71) Applicant: WATER PIK, INC., Fort Collins, CO (US)

(72) Inventor: Jeremy J. Johnson, Fort Collins, CO (US)

(21) Appl. No.: 17/519,324

(22) Filed: Nov. 4, 2021

(51) Int. Cl. A61C 17/22; A46B 5/00; A46B 9/04; A46B 9/08; A46B 13/02

(52) U.S. Cl. CPC A61C 17/222; A46B 5/0095; A46B 9/04; A46B 9/08; A46B 13/02

(57) ABSTRACT

A brush head for an oral cleansing device is disclosed. The brush head may include a brush body defining a shaft cavity, one or more contact pads coupled to the brush body and extending at least partially into the shaft cavity, and a biasing arm coupled to the brush body and extending at least partially into the shaft cavity, where the biasing arm exerts a biasing force towards the one or more contact pads.

### CROSS REFERENCE TO RELATED APPLICATIONS

This application is related to U.S. application Ser. No. 16/822,935 titled “Brush Head for Oral Cleansing Device,” filed on Mar. 18, 2020, which is incorporated by reference herein for all purposes.

### TECHNICAL FIELD

One or more embodiments of the present disclosure relate generally to oral cleansing devices and more particularly, for example, to systems and methods for a removable brush head of an oral cleansing device.

### BACKGROUND

Electric toothbrushes and/or combination units that provide a toothbrush function along with an irrigating function sometimes include a cleaning attachment removably connected to a drive system. The connection between the cleaning attachment and the drive system can break or wear out, such as due to repeated attachment and removal of the cleaning attachment to and from the drive system. This breakdown or wearing out of the connection between the cleaning attachment and the drive system may cause performance degradation over time. For example, the connection may lose its friction fit tolerances, leading to inefficient transfer of rotational motion of the drive system to the brush head. Additionally, many coupling features may require multiple components, which increase the cost and complexity of manufacturing of the cleaning attachment.

Therefore, there is a need in the art for systems and methods for a removable brush head or other accessory for an oral cleansing device that addresses the deficiencies noted above, other deficiencies known in the industry, or at least offers an alternative to current techniques.

### SUMMARY

According to one embodiment, a brush head for an oral cleansing device is disclosed. The brush head may include a brush body defining a shaft cavity, one or more contact pads coupled to the brush body and extending at least partially into the shaft cavity, and a biasing arm coupled to the brush body and extending at least partially into the shaft cavity, where the biasing arm exerts a biasing force towards the one or more contact pads.

According to one embodiment, an accessory for an oral cleansing device is disclosed. The accessory includes a brush body defining a shaft cavity and an attachment assembly positioned within the shaft cavity and configured to selectively couple to a shaft received within the shaft cavity and transfer motion from the shaft to the brush body. The attachment assembly includes a contact pad and a biasing arm partially extending into the shaft cavity, where the biasing arm exerts a biasing force in a direction towards the contact pad.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claimed invention or its applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the brush head or oral cleansing accessory described herein and should not be construed as a complete depiction of the scope of the brush head or cleansing accessory.

FIG. 1 is an isometric, partially exploded view of an oral cleansing device in accordance with an embodiment of the disclosure.

FIG. 2A is a rear elevation view of a brush head in accordance with an embodiment of the disclosure.

FIG. 2B is an exploded view of the brush head of FIG. 2A in accordance with an embodiment of the disclosure.

FIG. 3A is a front isometric view of a retainer in accordance with an embodiment of the disclosure.

FIG. 3B is a cross-section view of a retainer taken along line 3B-3B in FIG. 3A in accordance with an embodiment of the disclosure.

FIG. 4A is a rear isometric view of a biasing collar in accordance with an embodiment of the disclosure.

FIG. 4B is a is a cross-section view of a biasing collar taken along line 4B-4B in FIG. 4A in accordance with an embodiment of the disclosure.

FIG. 4C is a rear elevation view of a biasing collar in accordance with an embedment of the disclosure.

FIG. 5A is a cross-section view of a brush head coupled to a drive shaft in accordance with an embodiment of the disclosure.

FIG. 5B is an enlarged view of the cross-section of FIG. 5A in accordance with an embodiment of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

According to the present disclosure, a brush head is provided that improves a coupling between a drive shaft and the brush head. The brush head may also act to maintain the tightness of the coupling as components wear over time and/or experience external forces, such as a brushing force applied to the brush head by a user. The brush head may include a retainer or brush retention feature including an engagement arm, such as a cantilevered beam, that flexes to engage both with an outer surface of the drive shaft and an interior surface of the brush head. The engagement arm may be loaded when engaged with the drive shaft to help ensure a tight connection and transfer motion between the drive shaft and the brush head, e.g., allow the drive shaft to move the brush head, such as in an oscillating motion. In some implementations, the engagement arm may be configured to transition from a cantilevered beam as the drive shaft is inserted, e.g., including a single supported end, into a simply supported beam, with two supported ends. This may help to increase the force generated by the engagement arm, without requiring an increased form factor.

Optionally, the retainer may include a keyed or anti-clocking surface or element on an interior thereof. The keyed surface may engage with a corresponding keyed surface or feature on the drive shaft, such as a flat or recessed surface on the drive shaft, to prevent relative motion between the brush head and the drive shaft (e.g., ensure that the drive shaft does not oscillate within the brush head, but rather acts to oscillate the brush head itself). The keyed surface may also act to clock the brush head and drive shaft together, ensuring that they oscillate or move together at the same rotational rate. In some embodiments, the retainer may be formed as a unitary or integral component, helping to reduce manufacturing cost and increase ease of assembly as compared to conventional retaining features for oral cleansing devices.

The brush head may include a biasing collar that acts to ensure a tight fit between the drive shaft and an internal surface of the brush head. The biasing collar may include a biasing arm, such as an integrated biasing arm, which may be in the form of a cantilevered beam, that biases the drive shaft against one or more contact pads. The biasing force helps to ensure that the drive shaft is engaged or pressed against the one or more contact pads (either in the biasing collar or within the brush head) to help ensure a tight fit between the brush head and the drive shaft. The biasing force compensates for reduced thickness or wear between the components, e.g., worn down contact pads. In conventional brush heads, as components wear over time the coupling between the drive shaft and the brush head may begin to feel loose or “wobbly,” which may reduce the motion transfer to the brush head by the drive shaft, as well as create a poor user experience while using the oral cleansing device. The biasing collar helps to counteract wear between components and ensure a tight fit, even as components wear over time. Additionally, in some embodiments, the biasing arm may be configured to transition from a cantilevered beam to a simply supported beam as the drive shaft engages the biasing collar. This transition allows the force generated by the biasing arm to be increase as compared to conventional retaining structures, while allowing a small or reduced form factor.

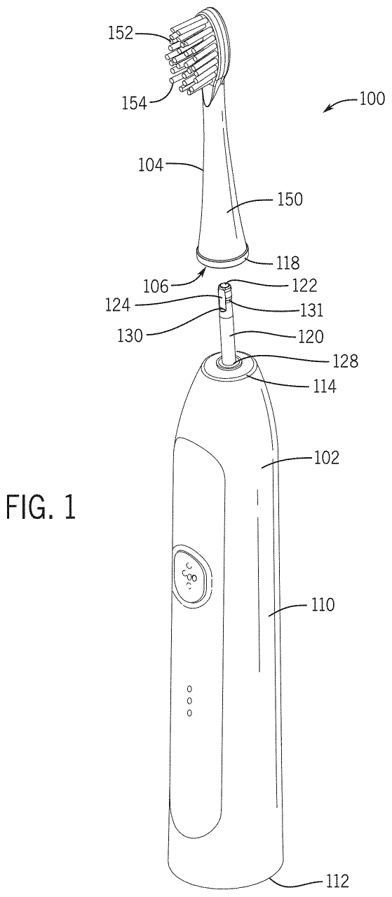

FIG. 1 illustrate an isometric, partially exploded view of an oral cleansing device 100 in accordance with an embodiment of the disclosure. The oral cleansing device 100 may include many configurations. For example, the oral cleansing device 100 may be in the form of a handheld device and include a handle 102 and a brush head 104. Depending on the application, the oral cleansing device 100 may be a toothbrush, an oral irrigator, a combination of a toothbrush and an oral irrigator, or any other handheld device designed for oral care. For example, in the embodiment illustrated in FIG. 1, the oral cleansing device 100 includes a brushing function. In other embodiments, however, the oral cleansing device 100 may be a combination brushing/irrigating device, a handheld oral irrigator, or other device with a cleaning attachment. In such embodiments, “brush head” may refer to any cleaning attachment that is securable to the handle 102 without intent to limit.

The handle 102 may include many configurations. For example, the handle 102 may be defined by a housing 110 that extends between a base end 112 and a brush end 114. The housing 110 may be generally cylindrical in shape to ergonomically fit in the hand of a user, although the housing 110 may be formed in any other desirable ergonomic shape. In some embodiments, the cylindrical shape of the housing 110 may taper in the direction of the brush end 114 to define a smooth transition or taper to the brush head 104. The base end 112 of the housing 110 may be generally flat such that the handle 102 may be stood upright on a level surface.

As shown, the handle 102 may include a drive shaft 120 extending from the brush end 114 of the housing 110 to drive operation of the brush head 104. For example, the drive shaft 120 may oscillate to cause corresponding oscillation of the brush head 104, as detailed more fully below. In such embodiments, the oral cleansing device 100 may include a power train assembly coupled to the drive shaft 120. The power train assembly may include many configurations operable to oscillate the drive shaft 120 and the brush head 104 connected thereto. An example of a power train assembly that may drive the drive shaft 120 is shown and described in U.S. Pat. No. 10,449,023 entitled “Oral Cleansing Device with Energy Conservation,” which is incorporated herein in its entirety for all purposes.

The drive shaft 120 may include one or more features facilitating attachment of the brush head 104 to the drive shaft 120. For example, the drive shaft 120 may include a tip 122 with a keyed feature 124, such as a flat defined thereon. In such embodiments, the tip 122 may include a non-circular cross-sectional shape that mates, at least partially, with a correspondingly-shaped structure of the brush head 104 to rotationally couple the brush head 104 to the drive shaft 120, as explained below. The drive shaft 120 may include a base 128 having a circular or substantially circular cross-section. In such embodiments, a shoulder 130 may be defined at a transition between the non-circular cross-sectional shape of the tip 122 and the circular cross-sectional shape of the base 128. A shaft retention feature 131 may be defined as a lip on an outer surface of the drive shaft 120 and may be positioned on an opposite side of the drive shaft 120 from the keyed feature 124 or flat and in some embodiments may be positioned between the tip 122 and the shoulder 130 of the drive shaft 120, such as in a middle portion of the keyed feature 124.

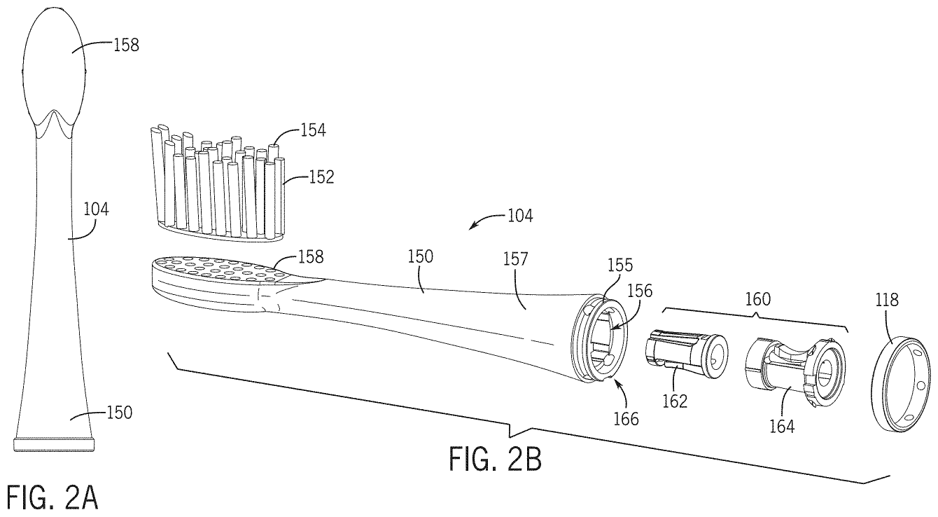

FIG. 2A illustrates a rear elevation view of the brush head 104 in accordance with an embodiment of the disclosure. FIG. 2B illustrates an exploded view of the brush head 104 in accordance with an embodiment of the disclosure. The brush head 104 may include the brush body 150 that may include a shaft portion 157 and a head portion 158 extending from one end thereof. The head portion 158 may define a bristle support or bristle base to which the cleaning elements 152, such as the bristles 154, may be coupled. A trim recess 155 may defined towards an end of the brush body 150, such as a bottom end opposite of the brush head 104. The trim recess 155 may be configured to receive a trim ring 118 thereon, which may be used as an identifier to correspond the brush head 104 to a particular user (e.g., different colored trim rings 118 may identify brush heads 104 belonging to different users). For example the trim recess 155 may define one or more recesses or apertures into which one or more detents on the interior surface of the trim ring 118 may seat to secure the trim ring 118 to the brush head 104.

The brush head 104 may also define an opening 166 at the bottom end where the opening 166 may define an entrance to a shaft cavity 156. The shaft cavity 156 may define a hollow or partially hollow cavity within the shaft portion 157 of the brush body 150. In shaft cavity 156 is configured to receive the drive shaft 120 of the handle 102 and in embodiments where the handle 102 may include an irrigating function may also include a fluid pathway or define a fluid pathway to fluidly couple a pump to the nozzle.

With reference to FIG. 2B, an attachment assembly 160 may be configured to be received within the shaft cavity 156 of the brush head 104. The attachment assembly 160 selectively secures the brush head 104 to the drive shaft 120 and enables the transfer of motion between the drive shaft 120 and the brush head 104, while reducing relative motion between the two.

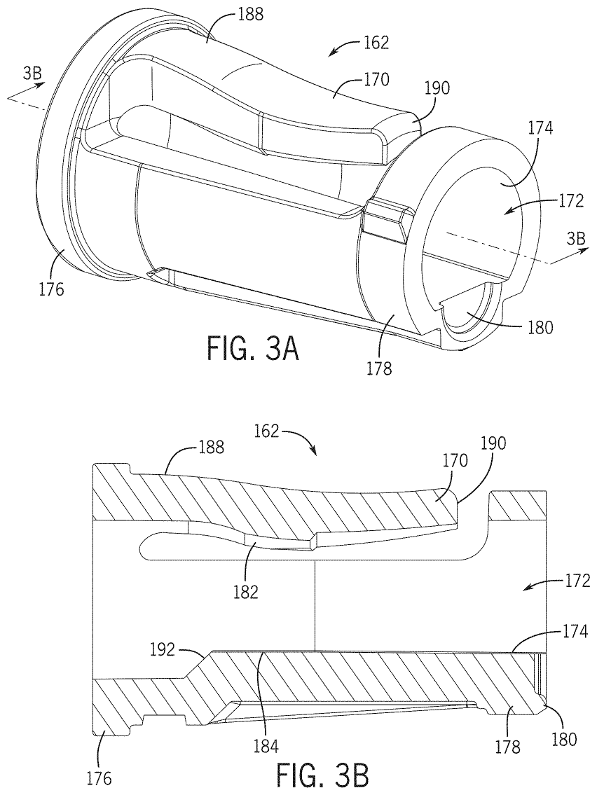

FIG. 3A and 3B illustrate views of a retainer 162 for the attachment assembly 160. The retainer 162 may be configure to couple the drive shaft 120 to the brush body 150 and transfer motion from the drive shaft 120 to the brush body 150. The retainer 162 may be defined as a general tubular body having a first end 176 and a second end 178, with a shaft passage 172 extending between the two ends 176, 178, where the shaft passage 172 is defined by an interior surface 174 or wall. The first end 176 may include an annular flange that extends about the outer surface of the retainer 162 and may be used to assist in securing the retainer 162 to the brush body 150. Similarly, the second end 178 may also define a flange or collar portion to assist in securing the retainer 162 within the brush body 150. The second end 178 may also include a keyed end 180, which may define a shoulder or tab extending radially outwards from the outer surface of the retainer 162. The keyed end 180 may also include a recessed surface on the terminal end thereof.

An engagement arm 170 may be defined on or coupled to the retainer 162. In many embodiments, the engagement arm 170 may be formed integrally with the retainer 162, reducing the number of components for the attachment assembly 160, reducing manufacturing cost and enabling ease of assembly. The engagement arm 170 may have an attached end 188 and a free end 190 so as to form a cantilevered and flexible beam. In one embodiment, the attached end 188 may be adjacent the first end 176 of the retainer and the free end 190 be adjacent to the second end 178 of the retainer 162, but in other configurations may be differently orientated. The engagement arm 170 may include a curvature along its length. In one example, the engagement arm 170 may include a dip or concave portion between the attached end 188 and the free end 190. Additionally, in some embodiments, a thickness of the engagement arm 170 may taper in the longitudinal direction, such that the attached end 188 may have a larger thickness than the free end 190, which may allow the engagement arm 170 to have an increased flexibility.

The engagement arm 170 is flexible and configured to exert a biasing or spring force to assist in securing the drive shaft 120 to the retainer 162 and the retainer 162 to the brush body 150 as discussed in more detail below. Further, a load may be distributed along the length of the engagement arm 170, which may help to prevent the engagement arm 170 from experiencing a failure (e.g., breaking) as the brush head 104 is inserted and removed from the drive shaft 120.

A retention feature 182 may be formed on an interior surface of the engagement arm 170, e.g., on an surface facing towards the shaft passage 172. The retention feature 182 may be formed as a raised or protruding surface feature and optionally may be oriented at location corresponding to the dip or concave portion of the engagement arm 170. In one example, the retention feature 182 may be defined as a flat surface on the bottom engagement arm 170. In this manner, the retention feature 182 may be located an interior most location for the engagement arm 170, e.g., a location positioned most closely to a center axis of the retainer 162.

With continued reference to FIGS. 3A and 3B, a keyed surface 184, which may be defined as a shaft keyed or flat surface, may be formed on an interior of the retainer 162, e.g., defined on an interior wall 174 of the retainer 162. The keyed surface 184 may be defined as a raised or protruding surface that extends into the shaft passage 172. In one example, the keyed surface 184 may include a beveled front edge 192 that transitions the interior wall 174 into the keyed surface 184. The shape and dimensions of the keyed surface 184 are configured to correspond to a corresponding keyed feature 124 on the drive shaft 120 and so may be varied to define a “fit” or coupling between the two components. The keyed surface 184 is configured to couple to the drive shaft 120 and prevent rotation of the drive shaft 120 relative to the retainer 162, e.g., ensure that all motion of the drive shaft 120 is transmitted to the retainer 162.

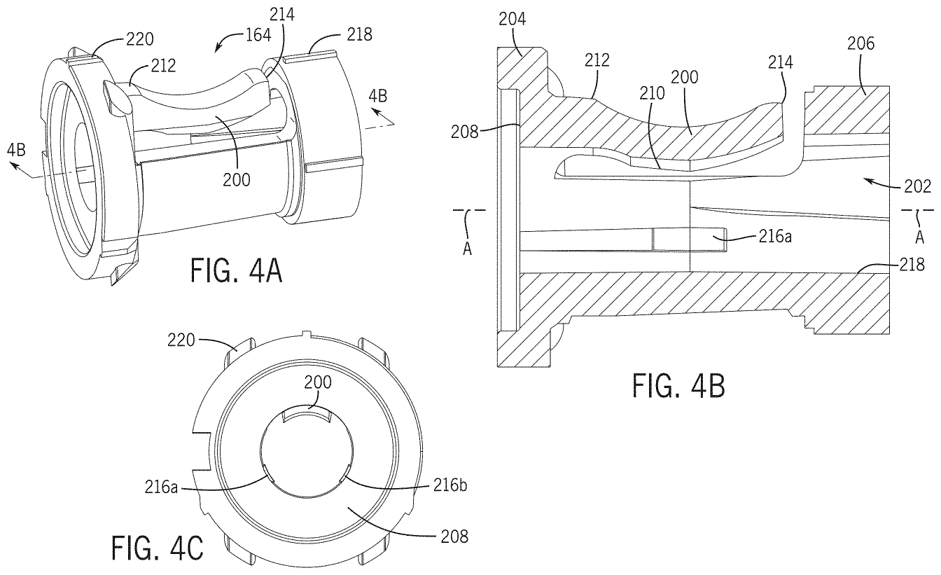

FIGS. 4A-4C illustrate various views of a biasing collar 164 that may form part of the attachment assembly 160. The biasing collar 164 is configured to exert a biasing coupling force on the drive shaft 120 to help retain the drive shaft 120 within the brush body 150 and maintain a tight connection, e.g., prevent a “wobble” or other relative movement between the brush body 150 and the drive shaft 120. The biasing collar 164 may be formed to include a hollow passageway, e.g., a shaft passageway 202 that extends between a first end 204 and a second end 206 of the biasing collar 164. A seating surface 208 or shelf may be inset from the first end 204 and define a seating surface to receive a component, such as a seal or mechanical coupling to secure the handle 102 to the brush body 150.

The first end 204 and second end 206 may include one or more alignment and/or securing features 218, 220, such as tabs, that may be defined as raised protrusions that extend about the outer surface of the biasing collar 164. The first end 204 and second end 206 may also define flanged portions that have a wider diameter than the intermediate sections of the biasing collar 164, which may act to assist in anchoring the biasing collar 164 within the brush body 150.

One or more contact pads 216a, 216b may be defined as raised protrusions on the interior surface 218 of the biasing collar 164. In one embodiment, there may be two contact pads 216a, 216b that may be positioned on opposite sides of a center axis of the biasing collar 164 one another, but in other embodiments, there may be fewer (e.g., one) or more (e.g., four) contact pads 216a, 216b. Similarly, although the contact pads 216a, 216b are shown as being positioned on the biasing collar 164, in other embodiments, the contact pads 216a, 216b may be formed within the brush body 150, such as within an interior surface of the brush body 150 defining the shaft cavity 156.

A biasing arm 200 may be defined a spring or flexible arm including an attached end 212 and a free end 214, where the biasing arm 200 has a longitudinal length extending parallel to a center axis C_{A} of the biasing collar 164. In one example, the attached end 212 may be positioned adjacent the first end 204 and the free end 214 may be positioned adjacent the second end 206, but in other embodiments may be differently configured (e.g., oriented in an opposite manner). The biasing arm 200 may have a concave curvature that curves inwardly towards the center axis C_{A} of the biasing collar 164 along a length of the biasing arm 200. This curvature may bias the biasing arm 200 towards the center axis of the biasing collar 164. The biasing arm 200 may be configured to be biased towards the shaft passage 202, which as described below, may assist in exerting a force on the drive shaft 120 to assist in engaging the drive shaft 120 with the contact pads 216a, 216b.

A coupling surface 210 or coupling pad may be defined on a bottom or interior surface of the biasing arm 200. In one example, the coupling surface 210 is defined as a flat surface on the interior curve surface of the biasing arm 200 and may correspond to a bottom most surface of the biasing arm 200, e.g., the portion of the biasing arm 200 positioned closest to the center axis C_{A} of the biasing collar 164. In some embodiments, the coupling surface 210 may function as a contact pad and define a flexible point of contact on the drive shaft 120 as discussed in more detail below.

The attachment assembly 160 may be positioned within the brush head 104. For example, the retainer 162 may be inserted through the opening 166 of the brush body 150 and into the shaft cavity 156. The second end 178 may be inserted first such that the keyed end 180 engages against an interior wall within the shaft cavity 156 of the brush body 150 and the first end 176 is oriented to face towards the bottom end of the brush body 150 (e.g., towards opening 166). The biasing collar 164 may be positioned within the brush head 104, such as positioned within the shaft cavity 156 adjacent to the retainer 162 and positioned between the retainer 162 and the opening 166 of the brush body 150. For example, the second end 206 of the biasing collar 164 may abut against the first end 176 of the retainer 162. The shaft passage 202 of the biasing collar 164 may align with the shaft passage 172 in the retainer 162, allowing the drive shaft 120 to extend through each of the biasing collar 164 and retainer 162. Optionally, the alignment features 218, 220 of the biasing collar 164 may be aligned with corresponding features, e.g., grooves or adjacent other ribs, to align and retain the biasing collar 164 within the cavity 156 of the brush body 150. Once positioned, the first end 204 of the biasing collar 164 may be aligned with and flush with the bottom end of the brush body 150. In some embodiments, both the retainer 162 and the biasing collar 164 may engage with the interior surfaces of the brush body 150 defining the shaft cavity 156, which will act to prevent relative rotation between the brush body 150 and the attachment assembly 160.

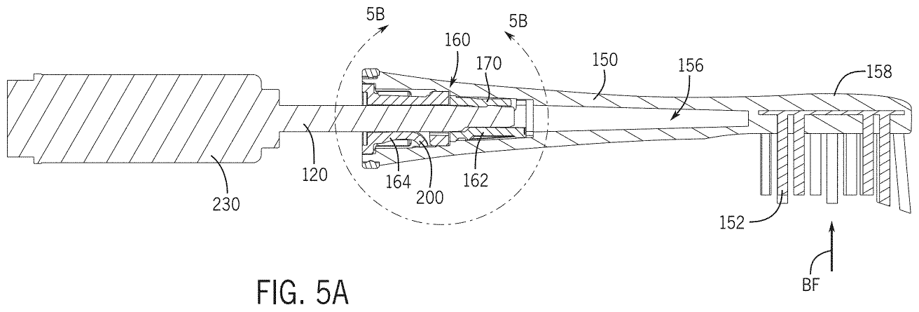

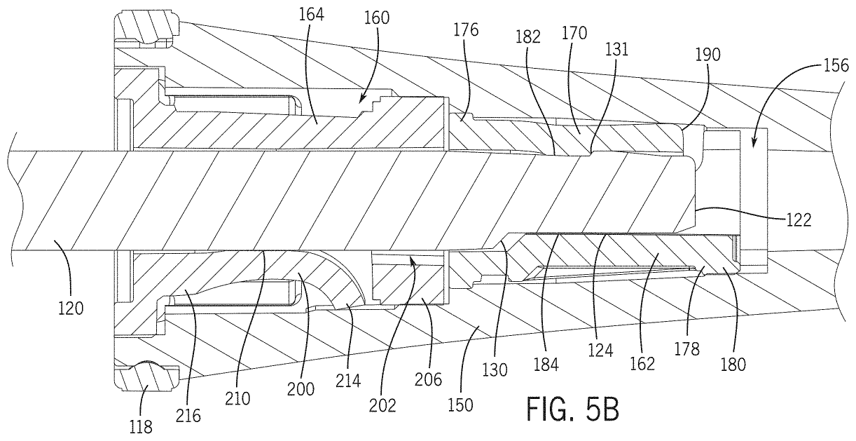

With reference to FIGS. 1, 5A, and 5B, to position the brush head 104 on the handle 102, the user may orient the brush head 104 such that the cleaning elements 152 are facing in the same direction as the faceplate 140 of the housing 110. The user inserts the drive shaft 120 into the opening 166 on the brush body 150 and through the shaft passage 202 of the biasing collar 164 and the shaft passage 172 of the retainer 162. The drive shaft 120 may slide within the biasing collar 164 and the retainer 162 until the beveled front edge 192 impacts the shoulder 130 of the drive shaft 120. The engagement between the beveled front edge 192 of the keyed surface 184 and the shoulder 130 of the drive shaft 120, prevents the drive shaft 120 from moving further along a length of the brush body 150. The keyed feature 124 or flat of the drive shaft 120 aligns with and engages the keyed surface 184 of the retainer 162. The keyed feature 124 of the drive shaft 120 may assist in ensuring that the drive shaft 120 is secured in a correct orientation relative to the brush head 104 and prevent the drive shaft 120 from being inserted and secured in incorrect orientations.

As the drive shaft 120 slides into engagement with the keyed surface 184 of the retainer 162, the drive shaft 120 exerts a force against the engagement arm 170, causing the engagement arm 170 to flex outwards, e.g., away from a center axis of the retainer 162, e.g., causing the free end 190 to move relative to the attached end 188 (see flexed position in FIGS. 5A and 5B). The retention feature 182 then engages the outer surface of the drive shaft 120, causing the engagement arm 170 to be secured in a flexed or deformed position. The free end 190 of the engagement arm 170, is flexed outwards and engages or abuts the interior wall of the brush body 150. With the engagement of the free end 190 against the interior wall, the engagement arm 170 may be converted from a cantilevered beam structure to a simply supported beam structure as the free end 190 is supported on the interior of the brush body 150. This may act to increase the rigidity of the engagement arm 170, which helps to increase the biasing force exerted by the engagement arm 170 against the drive shaft 120. In some embodiments, such a configuration may allow the retainer 162, and specifically, the engagement arm 170, to be smaller in dimension, allowing more compact constructions for the brush head 104.

With reference to FIG. 5B, the force exerted on the drive shaft 120 from the engagement arm 170 presses the keyed feature 124 of the drive shaft 120 against the keyed surface 184 of the retainer 162, preventing the drive shaft 120 from being inadvertently removed from the brush head 104. Additionally, when the drive shaft 120 is aligned on the keyed surface 184, the retainer 162 will act as a clocking feature, and translate motion from the drive shaft 120 to the brush body 150. The retainer 162 will also prevent relative motion between the drive shaft 120 and the brush body 150, e.g., all motion from the drive shaft 120 will transfer to the brush head 104 without slippage.

In some embodiments, as the drive shaft 120 is inserted, it may contact the retention feature 182, which causes the engagement arm 170 to bend or flex as substantially a rigid body. Due to this the insertion force to insert the drive shaft 120 into the retainer 162 may be relatively low.

As the drive shaft 120 is positioned within the brush head 104, the drive shaft 120 engages the biasing collar 164 and exerts a force on the coupling surface 210 of the biasing arm 200. This force causes the biasing arm 200 to flex or deform and the free end 214 to move away from the center axis C_{A} of the biasing collar 164. The free end 214 engages against an interior surface of the brush body 150 (see flexed position in FIGS. 5A and 5B). In some embodiments, as the free end 214 engages the interior surface or wall, the biasing arm 200 is converted from a cantilevered beam to a simply supported beam as the free end 214 is supported by the wall or surface. In these configurations, as with the engagement arm 170, the biasing arm 200 may become more rigid and be configured to exert an increased force as compared to conventional retaining structures, but at a smaller overall size. In other words, the biasing force exerted by the biasing collar 164 may be increased over other similarly sized but differently configured retention structures.

The curvature of the biasing arm 200 is biased or loaded and the coupling surface 210 acts to exert a force against the drive shaft 120. The force exerted forces the drive shaft 120 away from the coupling surface 210 and towards the interior surface 218 of the biasing collar 164. Specifically, the biasing arm 200 forces the drive shaft 120 towards the contact pads 216a, 216b, ensuring that the drive shaft 120 outer surface abuts against the contact pads 216a, 216b. Notably, even as the contact pads 216a, 216b or other features within the brush body 150 or the drive shaft 120 may wear and lose thickness over time, the force by the biasing collar 164 on the drive shaft 120 helps to ensure that the drive shaft 120 has multiple contact points within the attachment assembly 160. In other words, the biasing collar 164 counteracts loss in tolerance due to wear or the like, helping to define a tight fit between the drive shaft 120 and the brush head 104.

Once the brush head 104 is positioned on the handle 102, the user may activate the motor 230 to use the oral cleansing device 100. When activated, the motor 230 causes the drive shaft 120 to move, e.g., oscillate. Due to the clocked connection to the brush body 150 via the attachment assembly 160, the motion generated by the motor 230 is translated to the brush head 104, causing the brush head 104 to move correspondingly (e.g., oscillate). The attachment assembly 160 also prevents relative movement, such as slippage, between the drive shaft 120 and the brush body 150, helping to ensure that almost all motion generated is transferred to the brush head 104.

With reference to FIG. 5A, as a user places the brush head 104 in his or her oral cavity, e.g., along a tooth or gum surface, a brushing force B_{F} may be generated. The angle of the brushing force B_{F} will vary based on a position of the brush head 104 within the user's oral cavity, but often will be normal to the head portion 158 as the cleaning elements 152 may generally be oriented to be normal to the oral surface being cleaned. In these instances, the attachment assembly 160 and specifically the biasing arm 200 is configured to counteract such a force and flex against the interior surface of the brush body 150 to maintain the tight connection between the drive shaft 120 and the biasing collar 164. In other words, the biasing arm 200 may be biased in the direction of the brushing force Bf or biased in a direction normal or perpendicular to the head portion 158 and in an opposite direction.

When cleaning is done or the user otherwise wishes to remove the brush head 104 (e.g., for replacement or the like), the user may pull on the brush head 104 in direction opposite of the handle 102. This force overcomes the force generated by the retainer 162 and specifically the engagement arm 170, causing the engagement arm 170 to further deform, defining a gap between the retention feature 182 and the drive shaft 120, allowing the drive shaft 120 to move relative thereto. Similarly, the user force overcomes the force exerted by the biasing arm 200, allowing the drive shaft 120 to move or slide relative thereto. This allows the user to then continue to move the handle 102 or brush head 104 relative to the other, removing the drive shaft 120 from the shaft cavity 156.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A brush head for an oral cleansing device, the brush head comprising:
a brush body defining a shaft cavity;
one or more contact pads coupled to the brush body and extending at least partially into the shaft cavity; and
a biasing arm coupled to the brush body and extending at least partially into the shaft cavity, wherein the biasing arm exerts a biasing force towards the one or more contact pads.

2. The brush head of claim 1, further comprising:
a bristle support extending from the brush body; and
a plurality of bristles coupled to the bristle support, wherein the biasing arm is configured to increase the biasing force as a brushing force is applied to one or more of the plurality of bristles.

3. The brush head of claim 1, wherein the biasing force is configured to bias a shaft received within the shaft cavity against the one or more contact pads.

4. The brush head of claim 1, wherein the one or more contact pads comprises a first contact pad and a second contact pad.

5. The brush head of claim 1, further comprising a biasing collar positioned within the shaft cavity of the brush body, wherein the one or more contact pads are formed on an interior surface of the biasing collar.

6. The brush head of claim 5, wherein the biasing arm is formed on the biasing collar.

7. The brush head of claim 1, further comprising a retainer positioned within the shaft cavity, wherein the retainer is configured to engage a shaft received within the shaft cavity to couple the shaft to the brush body.

8. The brush head of claim 7, wherein the retainer further comprises an engagement arm that flexes to abut against an interior surface of the brush body.

9. The brush head of claim 8, wherein the engagement arm is defined as a cantilevered arm formed integrally with a body of the retainer.

10. The brush head of claim 9, wherein the engagement arm is converted to a simple supported beam after insertion of the shaft into the cavity.

11. The brush head of claim 8, wherein the engagement arm comprises a retention feature defined on an interior surface, wherein the retention feature is configured to engage an outer surface of a shaft received within the shaft cavity.

12. The brush head of claim 7, wherein the retainer further comprises a keyed surface defined on an interior surface of the retainer, wherein the keyed surface is configured to prevent the retainer from moving relative to a shaft received within the shaft cavity.

13. An accessory for an oral cleansing device comprising:
a brush body defining a shaft cavity; and
an attachment assembly positioned within the shaft cavity and configured to selectively couple to a shaft received within the shaft cavity and transfer motion from the shaft to the brush body, wherein the attachment assembly comprises:
a contact pad; and
a biasing arm partially extending into the shaft cavity, wherein the biasing arm exerts a biasing force in a direction towards the contact pad.

14. The accessory for an oral cleansing device of claim 13, wherein the attachment assembly further comprises a retention feature configured to engage an outer surface of the shaft.

15. The accessory for an oral cleansing device of claim 13, wherein the attachment assembly further comprises an engagement arm that flexes to engage an interior surface of the brush body.

16. The accessory for an oral cleansing device of claim 13, wherein the attachment assembly comprises a biasing collar, wherein the contact pad is formed on an interior surface of the biasing collar and the biasing arm is defined in part by an outer surface of the biasing collar.

17. The accessory for an oral cleansing device of claim 16, wherein the attachment assembly comprises a retainer comprising an engagement arm, wherein the engagement arm flexes to engage an interior surface of the brush body.

18. The accessory for an oral cleansing device of claim 17, wherein the engagement arm comprises a retention feature formed on an interior surface thereof and configure to engage an outer surface of the shaft.

19. The accessory for an oral cleansing device of claim 18, wherein the retainer further comprises a keyed surface defined on an interior surface thereof, wherein the keyed surface is configured to engage with a corresponding keyed surface on the shaft to prevent rotation of the shaft relative to the retainer.

20. The accessory for an oral cleansing device of claim 13, further comprising a plurality of bristles coupled to the brush body opposite an opening to the shaft cavity.

21. The accessory for an oral cleansing device of claim 13, wherein the biasing arm is configured as a cantilevered beam and transitions to a simply supported beam upon receipt of the shaft into the shaft cavity.

22. A toothbrush comprising the accessory for an oral cleansing device of claim 13.
